(19) United States
(12) Patent Application Publication
(10) Pub. No.: US 2017/0351346 A1
(43) Pub. Date: Dec. 7, 2017

(54) CONTROLLING AN ITEM ON A SCREEN

(71) Applicants: Yk HSIEH, Taipei (TW); Chung-Chun CHEN, Taipei (TW); Chih-Ming HUANG, Taipei (TW); Han-Kuang CHANG, Taipei (TW); Leo Joseph GERTEN, Taipei (TW); HEWLETT-PACKARD DEVELOPMENT COMPANY, LP., HOUSTON, TX (US)

(72) Inventors: YK HSIEH, TAIPEI CITY (TW); CHUNG-CHUN CHEN, TAIPEI CITY (TW); CHIH-MING HUANG, TAIPEI CITY (TW); HAN-KUANG CHANG, TAIPEI CITY (TW); LEO JOSEPH GERTEN, AUSTIN, TX (US)

(21) Appl. No.: 15/535,870

(22) PCT Filed: Feb. 6, 2015
(86) PCT No.: PCT/CN2015/072425

§ 371 Date: Jun. 14, 2017

(51) Int. Cl. G06F 3/0346; G06F 3/0482; G06F 3/0487

(52) U.S. Cl. CPC G06F 3/0346; G06F 3/0487; G06F 3/0482; G06F 2203/0331

(57) ABSTRACT

An example discloses a smart ring comprising a processor; a transceiver, wherein the transceiver is coupled to the processor to receive instruction from the processor and the transceiver is coupled to a computing device for transmitting data of the smart ring to the computing device and/or receiving data from the computing device; and a G-sensor, wherein the G-sensor is coupled to the processor and configured to detect up and down movement of the smart ring.

### BACKGROUND

Wearable devices become more and more popular nowadays. A smart ring, for example, as a kind of the wearable device, has been developed to detect heartbeats and measure a temperature of a body, for example. The smart ring can be worn on fingers to realize these functions. During operation of a computer, for example, a mouse is commonly used to control movement direction of a cursor or pointer on the screen of the computer; and a wheel of the mouse may be used to advance the playing speed of a player and move a page up and down on the screen or zoom in or out a picture on the screen. When a right button of the mouse is clicked, a menu is popped up showing options for a user to select. Now, it seems that the mouse becomes indispensable for users to operate the computer for example. The mouse however consumes more power than the smart ring does and has a bigger size than the smart ring so that it is not convenient to take the mouse around. Therefore, it is desirable to find a smaller and more portable object to replace the mouse.

### BRIEF DESCRIPTION OF THE DRAWINGS

The disclosure is described in detail in the following description in conjunction with the drawings. Features of the present disclosure are illustrated by way of non-limiting examples, in which:

FIG. 1 is a diagram of an example smart ring according to the disclosure;

FIG. 2 is a diagram of a 3D illustration of the smart ring according to the disclosure;

FIGS. 3A and 3B are diagrams of illustrations of the layout of two gyroscope sensors, two accelerometer sensors and a digital compass of the smart ring according to the disclosure.

FIGS. 4A and 4B are diagrams of 3D illustrations of the movements of the smart ring in the XY plane according to the disclosure;

FIG. 5A-5C are diagrams of comparison of the movements of the smart ring and mouse in the XY plane according to the disclosure;

FIG. 6 is a diagram of showing that the smart ring taps a surface according to the disclosure;

FIG. 7 is a diagram of implementing selection with tyre smart ring according to the disclosure;

FIG. 8 is a diagram of implementing selection of file folders with the smart ring according to the disclosure; and

FIG. 9 is a diagram of the smart ring flipping according to the disclosure.

FIG. 10A-C are diagrams of rotations of the smart ring according to the disclosure.

FIG. 11 is a diagram of a computing device's interaction with the smart ring according to the disclosure.

Throughout the drawings, identical reference numbers designate similar, but not necessarily identical, elements.

### DETAILED DESCRIPTION

In the following detailed description of examples of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

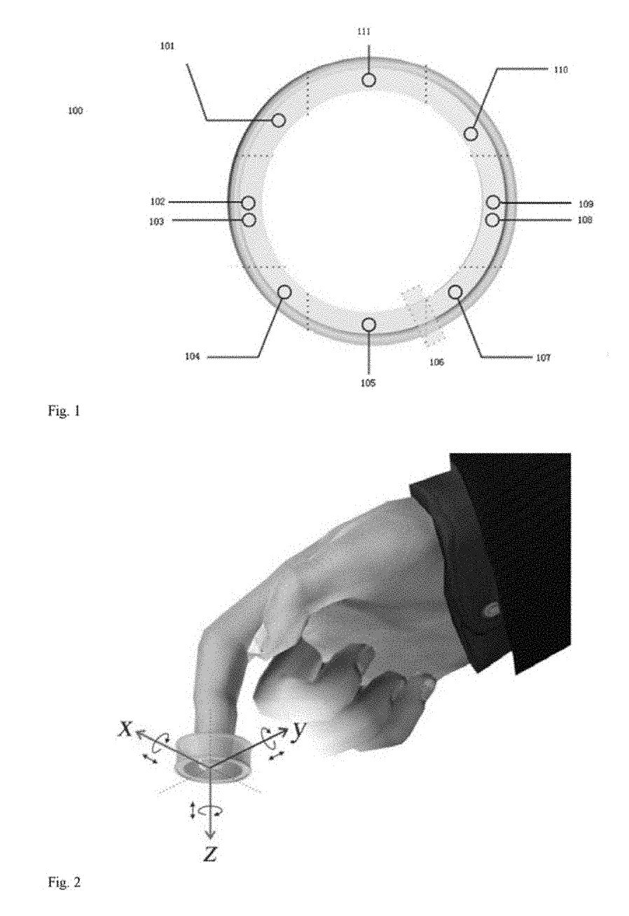

FIG. 1 shows a diagram of the example smart ring 100 according to the disclosure. The smart ring 100 can be made of any suitable materials such as wood, plastic, metal, stone and jade, etc.

A standard shape of the smart ring 100 is round, but the smart ring 100 can be made into any other shape with the inner surface being round so that it can be worn on the fingers of hands.

The size of the smart ring 100 may be fixed or may be adjusted to suit the sizes of the different fingers.

The smart ring 100 includes a transceiver 110 and a processor 111. The processor 111 may be of any type capable of processing data. In an example, the processor 111 is a low power CPU to save more energy for the smart ring 100. The transceiver 110 is coupled to the processor 111 to receive data from the processor 111 and send to the processor 111 data received from outside wirelessly. The transceiver 110 may be of any wireless type capable of transmitting and receiving data, such as a short range of radio, infrared and Bluetooth. In one example, the transceiver 110 may employ Bluetooth LE technology to save more energy for the smart ring 100. In one example, the smart ring 100 may include the battery 104. In another example, the smart ring 100 may include two or more batteries 104 and 107 to provide higher power. The batteries 104 and 107 could be button battery cells. In another example, the batteries 104 and 107 may be of rechargeable type. In another yet example, the batteries 104 and 107 may be rechargeable by means of wireless charging coil, which for example enwinds a portion of the smart ring 100 and is coupled to the batteries 104 and 107. In an example, the smart ring 100 includes the touch button 106 for example as a power switch. When the touch button 106 is pushed, the smart ring 100 will be turned on/off. In an example, the smart ring 100 can be turned on when it is slightly rocked and can be turned off when it is kept static for a certain period of time, for example 10 seconds, which can be set. In an example, the smart ring includes a G-sensor (gravity sensor) 101. The G-sensor 101 includes three axes X, Y and Z. The G-sensor 101 may be used to detect acceleration of the smart ring in its Z axis and output the detected acceleration to the processor 111. When the smart ring 110 is being lifted in the direction of Z axis, its value of acceleration is negative and when it is being put down, the value is positive. As the smart ring 100 starts to be lifted until it reaches the highest point, its value of acceleration changes from zero, maximum to zero. As the smart ring 100 starts to be put down until it becomes static, its value of acceleration changes from zero, maximum to zero. G-sensor 101 samples the value of acceleration of the smart ring in the direction of Z axis at interval of 100 ms for example. In an example, when the smart ring 100 is lifted and then is put down until to tap the desk, the action of smart ring 100 is considered as generating of a shock wave. When the value of acceleration of the smart ring 100 is detected to suddenly become zero within the shock threshold less them 100 ms, it is considered that the smart ring 100 taps the desk. The shock threshold is not fixed and depends on sensitivity of the employed G-sensor. The G-sensor 101 may be built in any location inside the smart ring 100. The G-sensor 101 is coupled to the processor 111 to send a signal indicative of the acceleration value in the Z axis of the smart ring 100. The smart ring 100 transmits the signal to the coupled computing device via the transceiver 110 so that when the computing device determines that the smart ring 100 is lifted and then put down or taps the desk, it instructs the pointer on the screen to select an item displayed on the screen. This is the same as when the left button of the mouse is clicked. In an example, if the computing device determines that the smart ring 100 taps the desk twice within a specified time, for example, 500 ms, then the computing device opens the selected item. This is the same as when the left button of the mouse is continuously clicked twice. In an example, the interval between the two consecutive tapping of the smart ring on the desk can be set to different value. In an example, when the computing device determines the interval is greater than 500 ms for example, it instructs the pointer on the screen to open the displayed item. This is the same as when the left button of the mouse is clicked twice. When the interval is less than 500 ms, it pops up the menu on the displayed item including the options for the user to select. This is the same as when the right button of the mouse is clicked. The value of interval is not limited to 500 ms and can be set to different values, depending on the user's preference or system requirements. In an example, the smart ting can tap the desk three times or four times or more. The user can define the function corresponding to the different times of tapping. For example, the three or four times of tapping will make the computing device enter into a sleep mode. For example, the three or four times of tapping will make the computing device shut down.

The tapping, of the smart ring 100 on the desk is not necessary. When the smart ring 100 is lifted and then put down and then kept static in the air, the effect is the same as when the smart ring 100 taps the desk.

In an example, the smart ring 100 includes two gyroscope sensors 102 and 109. The gyroscope sensors 102 and 107 are coupled to the processor 109. The gyroscope sensor could employ one-axis type, two-axis type or three-axis type.

The gyroscope sensors 102 and 09 may be used to detect rotation of the smart ring 100 in the vertical state and the horizontal state. In particular, the gyroscope sensors 102 and 109 detect rotation values of the X, Y and Z axes of the gyroscope sensors. The gyroscope sensors 102 and 109 have to be symmetrically built inside the smart ring 100 at the left side and the right side. In an example, they are built at the opposite ends of the diameter of the smart ring 100. The gyroscope sensor 109 is disposed differently from the gyroscope sensor 102 wherein the X and Y axes of the gyroscope sensor 109 are rotated counterclockwise or clockwise by 45° with respect to the corresponding axes of the gyroscope sensor 102. The gyroscope sensors 102 and 109 send to the processor 109 a signal indicative of rotation values of their X, Y and Z axes.

When the smart ring 100 is in the horizontal state, the gyroscope sensors 102 and 109 have their Z axes perpendicular with the desk. In this state, when the smart ring is rotated in the clockwise or counterclockwise, the Z axes of the gyroscope sensors 102 and 109 are rotated in the clockwise or counterclockwise. Then, the gyroscope sensors 102 and 109 send the signal to the processor 110 indicative of clockwise or counterclockwise rotation of the smart ring 100 in the horizontal state.

When the smart ring is in the vertical state, the gyroscope sensors 102 and 109 have their Z axes parallel with the desk. In this state, when the smart ring is rotated in the clockwise or counterclockwise, the Z axes are rotated in the clockwise or counterclockwise. Then, the gyroscope sensors 102 and 109 send the signal to the processor 110 indicative of clockwise or counterclockwise rotation of the smart ring 100 in the vertical state.

In case that the smart ring is in either the horizontal state or the vertical state, when the smart ring is rotated, only the Z axes of the gyroscope sensors 102 and 109 are rotated correspondingly and their X and Y axes are not rotated.

When the computing, device determines the clockwise or counterclockwise rotation of the smart ring, it will perform corresponding functions. This is the same as when the wheel of the mouse is rotated clockwise or counterclockwise. What can be performed in response to rotation of the smart ring will depend on the specific applications.

When the smart ring is flipped, all the three axes of the gyroscope sensors 102 and 109 are rotated accordingly. Then, the gyroscope sensors 102 and 109 send the signal to the processor 111 indicative of rotations of their X, Y and Z axes. When the computing device determines based on rotations of their X, Y and Z axes of gyroscope sensors 102 and 109 that the smart ring 100 is flipped until it taps the desk for example, it pops up the menu including options for selection on the selected item. This is the same as when the right button of the mouse is clicked. The different functions could be defined in response to flipping of the smart ring.

In an example, the smart ring includes two accelerometer sensors 103 and 108 and a digital compass 105. The two accelerometer sensors 103 and 108 and the digital compass 105 are coupled to the processor 111.

The two accelerometer sensors 103 and 108 may be used to detect movement of the smart ring 100 in the XY plane, for example, on the desk. The two accelerometer sensors 103 and 108 have to be symmetrically built inside the smart ring 100 at the left side and the right side. In an example, they are built at the opposite ends of the diameter of the smart ring 100. The accelerometer sensor 103 is built in a manner so that its X and Y axes are the standard setting. The accelerometer sensor 108 is disposed differently from the accelerometer sensor 103 so that the X and Y axes of the accelerometer sensor 108 are rotated counterclockwise by 45° with respect to the X and Y axes of the accelerometer sensor 103. The two accelerometer sensors 103 and 108 are coupled to the processor 109 to send the signal indicative of accelerations of the smart ring 100 in different directions of the X and Y axes of the accelerometer sensors 103 and 108. The digital compass 105 is disposed in the diameter and at the lowest point of the smart ring 100 and is used to point the south so that when the smart ring 100 is rotated on the desk, the pointing direction of the digital compass 105 can be used to transform coordinate system of X and Y axes or the two accelerometer sensors 103 and 108 into the default XY coordinate system. The first accelerometer sensor 103 has total four directions, positive X1+, negative X1−, positive Y1+ and negative Y1−. The second accelerometer sensor 108 has total four directions, positive X2+, negative X2−, positive Y2+ and negative Y2−. The respective angles between X1+ and X2+, X1− and X2−, Y1+ and Y2+, Y1− and Y2− are each 45° The two accelerometer sensors 103 and 108 detect different acceleration values from the eight directions when the smart ring 100 moves on the desk. Based on the acceleration values and the time the smart ring spends in moving, the distance of the smart ring travelling can be calculated. When the smart ring 100 moves on the desk, it sends the signal indicative of the respective acceleration values of the two accelerometer sensors 103 and 108 to the computing device.

The computing device calculates the corresponding moving speed and distance of the pointer on the screen in response to movement of the smart ring and then instructs the pointer to move correspondingly.

In example, the first gyroscope sensor 102 and the first accelerometer sensor 103 are integrated together and the second gyroscope sensor 109 and the second accelerometer sensor 108 are integrated together.

In example, the G-sensor 101, the first gyroscope sensor 102 and the first accelerometer sensor 103 are integrated together and the second gyroscope sensor 109 and the second accelerometer sensor 108 are integrated together.

FIG. 2 is a diagram of a 3D illustration of the smart ring according to the disclosure. It is assumed that the smart ring is placed on the desk and the center of the smart ring is the center of the coordinate system with the X, Y and Z axes and it is assumed that the direction of downward Z axis is the positive direction. When the smart ring is initialized, the X, Y and Z axes of the smart ring are determined by the respective G-sensor, gyroscope sensor and accelerometer sensor. Then, the smart ring sends the respective initial directions of X, Y and Z axes of the G-sensor, gyroscope sensor and accelerometer sensor to the computing device such as the computer, the laptop or the like, via the transceiver of the smart ring. The Vii-sensor detects acceleration of the smart ring in the Z axis; the gyroscope sensors detect rotation of the smart ring in the X, Y and Z axes; and the accelerometer sensors detects movements of the smart ring in the XY plane.

In an example, the outer surface of the smart ring could be set or affixed a label including a vertical letter, for example, “A” or “HP” in the thickness direction of the smart ring to indicate the positive Z axis and when the smart ring is flipped, the letter is reversed accordingly to indicate the negative axis, vice versa.

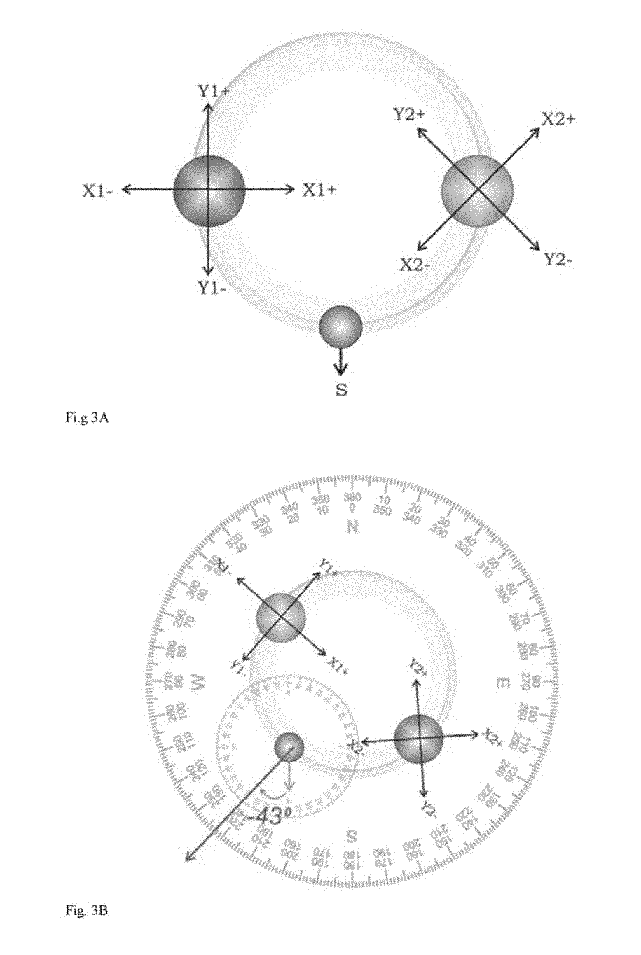

FIGS. 3A and 3B are diagrams of illustrations of the layout of two gyroscope sensors, two accelerometer sensors and the digital compass of the smart ring according to the disclosure.

FIG. 3A, the first gyroscope sensor and the first accelerometer sensor in the smart ring are disposed on the left; and the second gyroscope sensor and the second accelerometer sensor in the smart ring are disposed on the right. The first gyroscope sensor and the first accelerometer sensors in the smart ring are symmetrically with the second gyroscope sensor and the second accelerometer sensors. The second gyroscope sensor and the second accelerometer sensor are rotated counterclockwise by 45° with respect to the first gyroscope sensor and the first accelerometer sensor. The respective angles between X1+ and X2+, X1− and X2−, Y1+ and Y2+, Y1− and Y2− each are 45°. The digital compass is set parallel with Y1− direction of the first accelerometer sensor in the smart ring. Setting of FIG. 3A is considered as the default arrangement. In this arrangement, the compass just points to the South.

FIG. 3 B shows the smart ring as shown in FIG. 3A which is rotated clockwise by 43°. The computing device receives the offset angle 43° and transforms the XY axes of the accelerometer sensor to the standard XY axis by means of coordinate transformation.

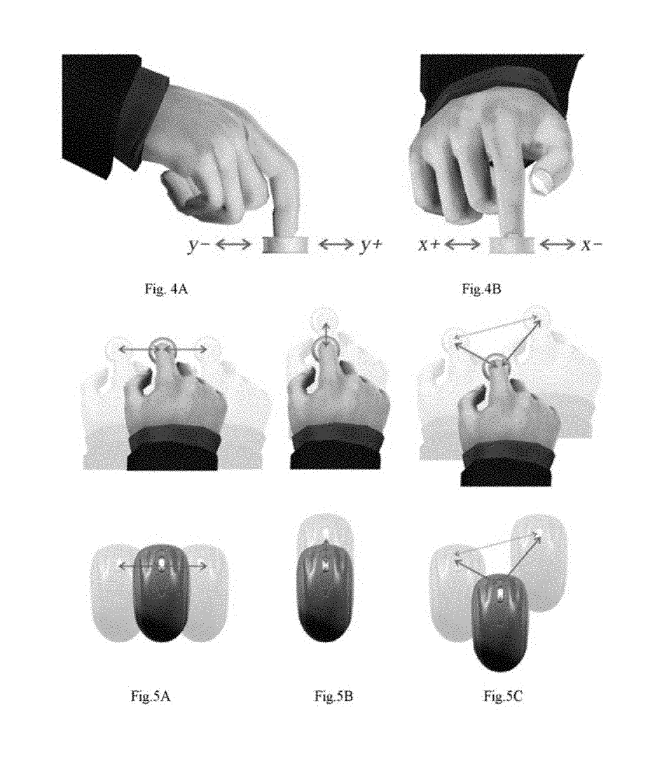

FIGS. 4A and 4B are diagrams of 3D illustrations of the movements of the smart ring in the XY plane according to the disclosure.

FIG. 4A shows that after the index finger inserts the smart ring on the desk for example, the finger moves the smart ring in the Y axis, for example from top to down or from down to top. When the smart ring is moving in the direction of Y axis, the accelerometer sensors send acceleration of Y axis to the processor and the processor sends them to the computing device for example. After the computing device receives the accelerations of the smart ring, it calculates the movement direction and speed of the pointer on the screen by calculating the distance of the smart ring travelling based on the acceleration values and the time the smart ring spends in moving. Then, the computing device instructs the pointer cursor or pointer to move in the determined Y direction.

FIG. 4B shows that after the index finger inserts the smart ring on the desk for example, the finger moves the smart ring in the X axis, for example from the left to the right or from the right to the left. When the smart ring is moving in the direction of X axis, the accelerometer sensors send acceleration of X axis to the processor and the processor sends them to the computing device for example. After the computing device receives the accelerations of the smart ring, it calculates the movement direction and speed of the pointer on the screen by calculating the distance of the smart ring travelling based on the acceleration values and the time the smart ring spends in moving. Then, the computing device instructs the pointer cursor or pointer to move in the determined X direction.

As a matter of fact, the smart ring does not necessarily move exactly in the just X axis or the just Y axis. In this case, the computing device calculates the movement direction and speed of the cursor or pointer on the screen based on 8 accelerations of the 8 axes of the two accelerometer sensors and then instructs the pointer on the screen to move in the calculated directions. When the compass indicates the smart ring is rotated, then it will send the offset angle value. In this case, the computing device will transform the X and Y axes of the two accelerometer sensors to the default coordinate system to calculate the movement of the pointer.

FIG. 5A-5C are diagrams of comparison of the movements of the smart ring and mouse in the XY plane according to the disclosure. The computing device calculates the movement direction of the smart ring according to discussion in connection with FIGS. 4A and 4B.

FIG. 5A shows comparison of the movement of the smart ring and the mouse in the X direction. After the index finger inserts into the smart ring and then moves it in the X axis, the pointer on the screen moves in the X axis. This is the same as when the mouse moves in the X axis.

FIG. 5B shows comparison of the movement of the smart ring and the mouse in the Y direction. After the index finger inserts into the smart ring and then moves it in the Y axis, the pointer on the screen moves in the Y axis. This is the same as when the mouse moves in the Y axis.

FIG. 5C shows comparison of the movement of the smart ring and the mouse from the first point over on the left to the second point over on the right. After the index finger inserts into the smart ring and then moves it from the first point to the second point, the pointer on the screen moves from the first point and the second accordingly. This is the same as when the mouse moves from the first point and the second point.

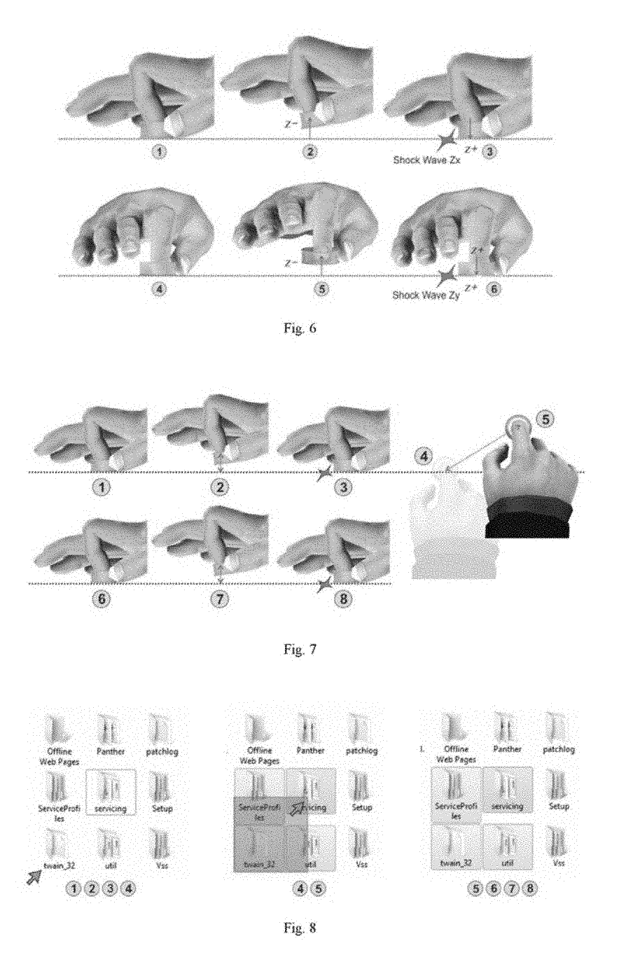

FIG. 6 is a diagram of showing that the smart ring taps the surface of the desk according to the disclosure. In the first case, the smart ring taps the desk once only. At the step 1, the fingers hold the smart ring. At the step 2, the fingers lift the smart ring. As the smart ring is being lifted, the G-sensor built in the smart ring sends to the processor data indicative of its values of acceleration of the smart ring in the Z axis of the G-sensor. The processor semis the data to the computing device for example through the transceiver of the smart ring. Then, the computing device knows that the smart ring is rising. At the step 3, the fingers make the smart ring suddenly go down and then tap the desk for the example. When the smart ring taps the desk, it actually stops temporarily. Meanwhile, the G-sensor may detect the shock wave due to the smart ring tapping the desk. During the period, the acceleration of the smart ring becomes zero. Then, the G-sensor in the smart ring sends data indicative of the shock wave to the processor. The processor sends to the computing device the data through the transceiver of the smart ring. If the computing device decodes the data indicative of the shock wave or lifting—putting down, then it instructs the pointer to select an item displayed on the screen. This is the same as when the left button of the mouse is clicked once. Through the steps 4-6, the smart ring taps the desk one again. If the computing device determines the smart ring taps the desk twice within the specified time, it instructs the pointer to open the item such as a file or file folder. This is the same as when the left button of the mouse is clicked twice on the displayed items. The interval between the two consecutive tapping of the smart ring on the desk can be set to different value. In an example, when the computing device determines the interval is greater than 500 ms for example, it instructs the pointer to open the displayed item. When the interval is less than 500 ms, it pops up the menu on the displayed item including the options for the user to select. This is the same as when the right button of the mouse is clicked. The value of interval is not limited to 500 ms and can be set to different values, depending on the user's preference or system requirements. In an example, the smart ring can tap the desk three times or four times or more. The user can define the function corresponding to the different times of tapping. For example, the three or four times of tapping will make the computing device enter into a sleep mode. For example, the three or four times of tapping will make the computing device shut down.

FIG. 7 is a diagram of implementing selection with the smart ring according to the disclosure. The steps 1, 2 and 3 and the steps 6, 7 and 8 are the same as the steps 1, 2 and 3 as stated in connection with FIG. 6 wherein the finger lifts the smart ring and then taps the desk with the smart ring. This generates the shock wave at steps 3 and 8 which is detected by the G-sensor and is then sent to the computing device. After the computing device determines the shock wave, it instructs the pointer to select the item displayed on the screen. Then, from the step 4 to the step 5, the pointer on the screen is moving from the first point (X1, Y1) to the second point (X2, Y2) as the smart ring is moving from the first point to the second on the desk. At the step 5, the smart ring stops. Then, through the steps 6, 7 and 8, the smart ring taps the desk once again. As a result, all the items failing an area of |Y2−Y1|×|X2−X1| from the first point to the second point are selected. The function of selection is implemented by the following steps: tapping the desk with the smart ring at the first point for the first times; moving the smart ring from the first point to the second point and then tapping the desk with the smart ring for the second times at the second point, causing all the items within the area of |Y2−Y1|×|X2−X1| to be selected.

FIG. 8 is a diagram of implementing selection of the file folders with the smart ring according to the disclosure. This example shows how to select file folders with the smart ring. For example, when the smart ring is moved so that the pointer falls on the file folder of “twain_32”, the smart ring is used to tap the desk to generate the first shock wave. Then the file folder of twain_32 is selected through the steps 1, 2 and 3. At the step 4, the smart ring is moved toward the front right until the file folder of “servicing” is past through the steps 4 and 5. As a result, the desirable four file folders of “Service Profiles”. “servicing”, “twain_32.” and “util” fall within the area determined by the second coordinate set of (X2, Y2) at the top right-corner of the file folder of “servicing” and the first coordinate set of (X1, Y1) at the bottom-left corner of the file folder of “twain_32”. Then, the fingers lift the smart ring and tap the desk with it to generate the second shock wave. As a result, all the four file folders of “Service Profiles”, “servicing”, “twain 32” and “util” are selected through the steps 6, 7 and 8. Then, the four file folders could be copied, past or deleted for example by selecting different options on the popped menu on the screen.

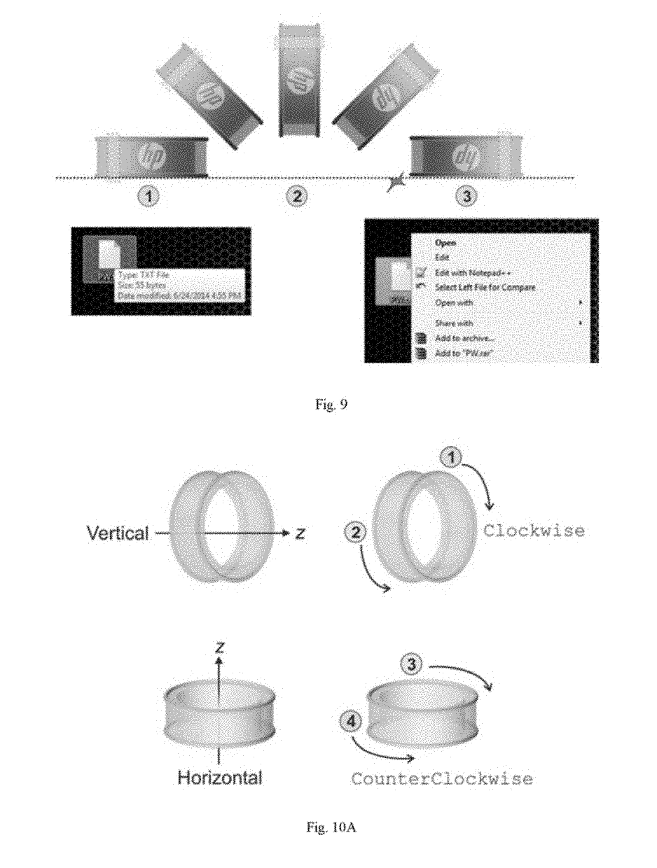

FIG. 9 is a diagram of the smart ring flipping according to the disclosure. At the step 1, the fingers hold the smart ring and then tap the desk with the smart ring to select the desirable item on the screen. At the step 2, after the item is selected, the fingers flip the smart ring. At the step 3, the flipped smart ring taps the desk to generate the shock wave. During the period, the gyroscope sensors 102 and 107 send to the processor data indicative of rotations of the X, Y and Z axes. After the smart ring is flipped, the computing device receives rotation values of the X, Y and Z axes and then determines that the smart ring is being flipped. Then, the G-sensor detects the shock wave due to the flipped smart ring tapping the desk. As above stated, the computing device can determine the shock wave by detecting the data from the G-sensor. When the computing device determines both the flipping and the shock wave of the smart ring, it pops up the menu, including the option of “Open” and “Edit” for example, on the selected item such as the file. In an example, when the selected item is a text file, the popped menu includes the size and creation time of the file, etc. What to be displayed on the menu depends on the specific item or application. This is the same as when the right button of the mouse is clicked on the selected item. Please note that the flipping of the smart ring can be defined based on the user's preference for example to realize other functions than popping of the menu. For example, when the smart ring is flipped, the computing device is locked or shut down.

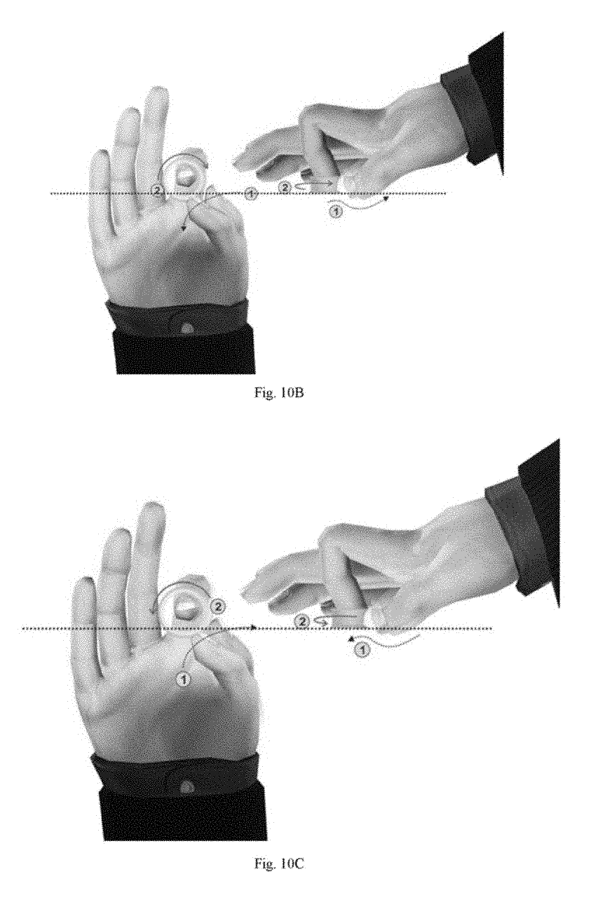

FIG. 10A-C are diagrams of rotations of the smart ring according to the disclosure. The upper portion of FIG. 10A shows that when the smart ring worn on the finger for example is erected, it can be rotated clockwise or counterclockwise. The lower portion of FIG. 10A shows that when the smart ring is placed in parallel with the desk for example, it can be rotated clockwise or counterclockwise as well. FIG. 10B shows that the smart ring is rotated clockwise in the vertical state or in the horizontal state. FIG. 10C shows that the smart ring is rotated counterclockwise in the vertical state or in the horizontal state.

In an example, in case that the user is viewing the picture in a gallery and the smart ring is in the horizontal state, the computing device zooms the picture in as the smart ring is rotated clockwise; and the computing device zooms it out as the smart is rotated counterclockwise, vice versa. In case that the user is viewing the picture and the smart ring is in the vertical state, the computing device goes to the previous picture as the smart ring is rotated clockwise; and the computing device goes to the next picture as the smart is rotated counterclockwise, vice versa. The different functions of zooming in or out and going to the previous or next picture could be predefined or changed before the smart ring is rotated.

In an example, in case that, the user is playing a son or video or the like with the multimedia player and the smart ring is in the horizontal state, the computing device makes the player go forward as the smart ring is rotated clockwise; and the computing device makes the player rewind as the smart is rotated counterclockwise, vice versa. In case that the user is playing the song or video or the like and the smart ring is in the vertical state, the computing device instructs the player jump to the previous item such as a song as the smart ring, is rotated clockwise; and the computing device instructs the player to go to the next song, vice versa. The different functions of forwarding or rewinding or jumping to the previous or next item could be predefined or changed before the smart ring is rotated

In an example, in case that the user is making presentation and the smart ring is in the horizontal state, the computing device zooms in the slide as the smart ring is rotated clockwise; and the computing device zooms out the slide as the smart is rotated counterclockwise, vice versa. In case that the user is making presentation and the smart ring in the vertical state, the computing device jumps to the previous slide as the smart ring is rotated clockwise; and the computing device jumps to the next page as the smart ring is rotated counterclockwise, vice versa. These different functions in the example could be predefined or changed before the smart ring is rotated

In an example, in case that the focused item on the screen is a sliding bar and the smart ring is in the horizontal state, the computing device moves the bar to the right as the smart ring is rotated clockwise. In case that the smart ring is rotated counterclockwise in the example, the computing device moves the bar to the left, vice versa. In case that the focused item on the screen is the sliding bar and the smart ring is in the vertical state, the computing device moves the bar upward as the smart ring is rotated clockwise. As the smart ring is rotated counterclockwise in this case, the computing device moves the bar downward.

The above just presents some example of how to define different functions with the rotations of the smart ring, but it is appreciated that the functions corresponding to the rotations of the smart ring should not be construed in the limitation sense. The other functions which can realized by rotating the smart ring can be practiced within the scope of the spirit of the disclosure.

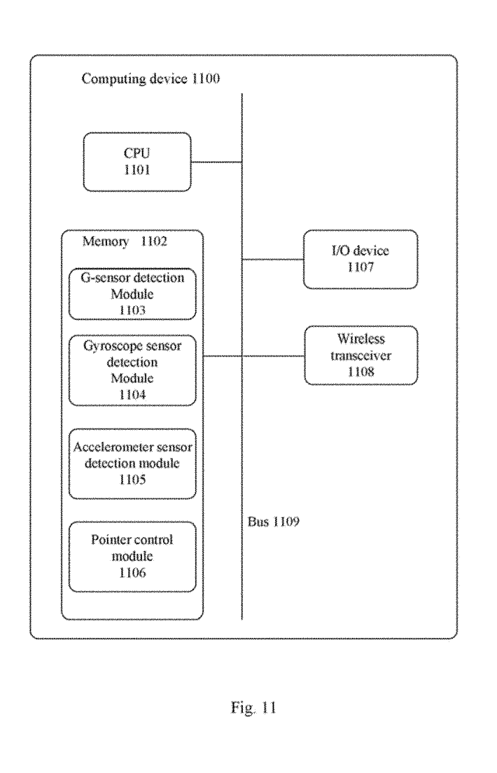

FIG. 11 is a diagram of the computing device's interaction with the smart ring according to the disclosure. The computing device 1100 may be the computer, laptop, tablet or any other device which may use the mouse to control the pointer or cursor on the screen. The computing device 1100 includes one or more processors CPU 1101, a memory 1102 (e.g., random access memory (RAM), cache memory, flash memory, etc.), which stores instructions to be executed by the CPU 1101, I/O device 1107 such as a keyboard, a microphone, a speaker or a monitor (not shown) and a wireless transceiver 1108. The CPU 1101, the memory 1102, the I/O device 1107 and the wireless transceiver 1108 are coupled with each other via a bus 1109. The wireless transceiver 1108 may be of any wireless type capable of transmitting and receiving data, such as a short range of radio, infrared and Bluetooth. In one example, the transceiver 1108 may employ Bluetooth LE technology when the smart ring is provided with the Bluetooth LE transceiver. In another example, the computing device 1100 include more than one wireless transceivers 1108, each of which is provided with different communication technologies so that the computing device 1100 can interact with the different smart rings provided with different communication technologies.

The memory 1102 includes the G-sensor detection module 1103, the Gyroscope sensor detection module 1104, the Accelerometer sensor detection module 1105 and the pointer control module 1106.

The G-sensor detection module 1103 receives the data from the G-sensor of the smart ring. When the data from the G-sensor is indicative of the shock wave due to the smart ring tapping the desk, for example, the G-sensor detection module 1103 sends to the pointer control module 1106 the instruction to select the item on the screen. This is the same as when the left button of the mouse is clicked once. When the G-sensor detection module 1103 receives the data from the G-sensor indicative of the consecutive two shock waves within the specified interval due to the smart ring tapping the desk twice, it sends to the pointer control module the instruction to open the selected item such as a file or file folder. This is the same as the left button of the mouse is clicked twice. The interval between the twice tapping of the smart ring can be set to different value. In an example, when the G-sensor detection module 1103 determines the interval is greater than 500 ms for example, it sends to the pointer control module 1106 to open the file. When the interval is less than 500 ms, the pointer control module 1106 instructs the pointer to pop up the menu on the selected item. This is the same as the right button of the mouse is clicked on the selected item. The value of interval is not limited to 500 ms and can be set to different values, depending on the user's preference or application requirements. When the G-sensor detection module 1103 receives the data indicative of the smart ting consecutively tapping the desk three times or four times or more within the specified intervals, the pointer control module 1106 could realize the different function as defined by the user. For example, the user can define the function corresponding to the different times of tapping. For example, the three or four times of tapping will make the computing device enter into a sleep mode. In another example, the three or four times of tapping will make the computing device shut down.

The Accelerometer sensor detection module 1105 receives acceleration values of the accelerometer sensors of the smart ring in different directions of the X and Y axes of the accelerometer sensors via the transceiver 1107 and then calculates the movement direction and speed of the pointer on the screen by calculating the distance of the smart ring travelling based on the acceleration values and the time the smart ring spends in moving on the desk. Then, the Accelerometer sensor detection module 1105 instructs the pointer control module 1106 to move the pointer in the calculated direction. When the computing device receives the offset angle value as detected by the compass, it will transform the X and Y axes of the two accelerometer sensors to the default coordinate system to calculate the movement of the pointer and then calculates the movement direction and speed of the pointer on the screen by calculating the distance of the smart ring travelling based on the acceleration values and the time the smart ring spends in moving on the desk.

In an example, the accelerometer sensor detection module 1105 also receives the offset angle from the digital compass so that it transforms the coordinate system to the standard one based on the angle. When the smart ring moves just in case the offset angle is always zero, the offset angle from the digital compass is not required.

In an example, the memory 1102 further includes a compass detection module for receiving the offset angle from the digital compass which the accelerometer sensor detection module 1105 can use to transform the coordinate system to the standard one.

When the gyroscope sensor detection module 1104 receives data indicative of rotation values of the X, Y and Z axes of the gyroscope sensor of the smart ring due to the smart ring flipping and then G-sensor detection module 1103 receives data indicative of the shock wave due to the smart ring tapping the desk, they send messages to the pointer control module 1106. Then, the pointer control model 1106 determines both flipping and the shock wave of the smart ring, it instructs the pointer to pop up the menu on the selected items. The menu includes the options of “Open” and “Edit”, for example. In an example, when the selected item is a .text file, the popped menu includes the size and creation time of the file, for example. This is the same as when the right button of the mouse is clicked on the selected item. Please be noted that what the flipping of the smart ring can realize, for example realizing other functions than the popping of the menu, can be defined based on the user's preference. For example, when the gyroscope sensor detection module 1104 receives data indicative of flipping of the smart ring, it sends the instruction to the pointer control module 1106 to lock the computing device or shut it down.

When the gyroscope sensor detection module 1104 receives data indicative of clockwise or counterclockwise rotation of the smart ring, it sends instructions to the pointer control module 1106 to implement different functions corresponding to different rotations of the smart ring.

In an example, in case that the gyroscope sensor detection module 1104 detects that the smart ring is rotated clockwise in the horizontal state, the pointer control module 1106 zooms the picture in when the user is viewing the picture in the gallery; and in case that the gyroscope sensor detection module 1104 detects that the smart ring is rotated counterclockwise, the pointer control module 1106 zooms the picture out, vice versa. In case that the gyroscope sensor detection module 1104 detects that the smart ring is rotated clockwise in the vertical state, the pointer control module 1106 makes the screen display jump to the previous picture; and in case that the gyroscope sensor detection module 1104 detects that the smart ring is rotated counterclockwise, the pointer control module 1106 makes the screen display jump to the next picture, vice versa. These different functions in the example could be predefined or changed before the smart ring is rotated.

In an example, in case that the gyroscope sensor detection module 1104 detects that the smart ring is rotated clockwise in the horizontal state, the pointer control module 1106 makes the player forward when the user is playing the song or video or the like; and in case that the gyroscope sensor detection module 1104 detects that the smart ring is rotated counterclockwise, the pointer control module 1106 makes the player rewind, vice versa. In case that the gyroscope sensor detection module 1104 detects that the smart ring is rotated clockwise in the vertical state, the pointer control module 1106 makes the player jump to the previous item such as a song; and in case that the gyroscope sensor detection module 1104 detects that the smart ring is rotated counterclockwise, the pointer control module 1106 makes the player go to the next song, vice versa. These different functions in the example could be predefined or changed before the smart ring is rotated.

In an example, in case that the gyroscope sensor detection module 1104 detects that the smart ring is rotated clockwise in the horizontal state, the pointer control module 1106 zooms in the slide in when the user is making presentation; and in case that the gyroscope sensor detection module 1104 detects that the smart ring is rotated counterclockwise, the pointer control module 1106 zooms out the slide, vice versa. In case that gyroscope sensor detection module 1104 detects that the smart ring is rotated clockwise in the vertical state, the pointer control module 1106 makes the slide jump the previous one; and in case that the gyroscope sensor detection module 1104 detects that the smart ring is rotated counterclockwise, the pointer control module 1106 makes the slide jump to the next one, vice versa. These different functions in the example could be predefined or changed before the smart ring is rotated.

In an example, in case that the focused item on the screen is the sliding bar and the smart ring is in the horizontal state, the computing device moves the bar to the right as the smart ring is rotated clockwise. In case that the smart ring is rotated counterclockwise, the computing device moves the bar to the left, vice versa. In case that the focused item on the screen is the sliding bar and the smart ring is in the vertical state, the computing device moves the bar upward as the smart ring is rotated clockwise. As the smart ring is rotated counterclockwise, the computing device moves the bar downward. These different functions in the example could be predefined or changed before the smart ring is rotated.

While the disclosure has been described with respect to a limited number of examples, those skilled in the art, having benefit of this disclosure, will appreciate that other example embodiments can be devised which do not depart from the scope of the disclosure as disclosed herein. Accordingly, the scope of the disclosure should be limited only by the attached claims.

1. A smart ring comprising:
a processor;
a transceiver, wherein the transceiver is coupled to the processor to receive instruction from the processor and the transceiver is coupled to a computing device for transmitting data of the smart ring to the computing device and/or receiving data from the computing device; and
a G-sensor,
wherein the G-sensor is coupled to the processor and configured to detect up and down movement of the smart ring.

2. The smart ring according to claim 1, wherein the up and down movement of the smart ring includes tapping of the smart ring on the desk.

3. The smart ring according to claim 1, wherein the smart ring further comprises:
two gyroscope sensors being symmetrically disposed on two sides of the smart ring;
wherein the two gyroscope sensors are coupled to the processor and configured to detect rotation of the smart ring in the horizontal state or the vertical state.

4. The smart ring according to claim 3, wherein the two gyroscope sensors is further configured to detect flipping of the smart ring.

5. The smart ring according to claim 3, wherein the smart ring further includes the two accelerometer sensors which are symmetrically disposed on two skies of the smart ring and a digital compass which is disposed in the diameter of the smart ring and on the lowest point of the smart ring;
wherein the diameter is perpendicular to a line between the two accelerometer sensors;
wherein the two accelerometer sensors and the digital compass are used to determine movement of the smart ring on a desk.

6. The smart ring according to claim 1, herein a label is set on the thickness direction of the smart ring to identify Z axis of the smart ring.

7. The smart ring according to claim 1, wherein the smart ring further includes a rechargeable battery.

8. The smart ring, according to claim 7, wherein the smart ring further includes wireless charging coil for charging the battery.

9. A computing device including:
a processor;
a transceiver, wherein the transceiver is coupled to the processor and a smart ring according to claim;
a G-sensor detection module, wherein the G-sensor detection module receives data indicative of acceleration values of the smart ring in the Z axis of the G-sensor;
a Gyroscope sensor detection module, wherein the Gyroscope sensor detection module receives data indicative of rotation values of the smart ring in the X, Y and Z axis of the Gyroscope sensor;
an accelerometer sensor detection module which receives d to indicative of acceleration values of the smart ring in the XY plane; and
a pointer control module wherein the pointer control module operates an item on the screen responsive to instructions from the G-sensor detection module and/or Gyroscope sensor detection module and/or accelerometer sensor detection module.

10. The computing device according to claim 9, wherein when the G-sensor detection module indicates the smart ring is tapped on the desk, the pointer control module selects the item displayed on the screen of the computing device.

11. The computing device according to claim 9, wherein when the G-sensor detection module indicates the smart ring is flipped and then tapped on a desk, the pointer control module pops up a menu including options on the selected item.

12. The computing device according to claim 9, wherein when the accelerometer sensor detection module indicates the smart ring is moved in the XY plane, the pointer control module instructs a pointer on the screen to move.

13. The computing device according to claim 9, wherein when the G-sensor detection module indicates the smart ring is tapped on a desk and then the accelerometer sensor detection module indicates the smart ring is moved in the XY plane and then the G-sensor detection module indicates the smart ring is tapped on the desk for the second times, the pointer control module instructs the pointer to select all items within an area formed by the coordinates of the starting point and the coordinates of the stopping point of the pointer.

14. The computing device according to claim 9, wherein when the Gyroscope sensor detection module indicates the smart ring is rotated clockwise or counterclockwise in either a vertical state or a horizontal state, the pointer control module is to
(1) make a player forward, rewind, jump to the next item or previous item, or
(2) move a sliding, bar to the left, move it to the right, moves it upward or moves it downward; or
(3) zoom a picture in or out or jumps td the previous picture or next picture; or
(4) zoom a slide of presentation in or out or jumps to the previous slide or next slide.

15. The computing device according to claim 9, wherein when the G-sensor detection module indicates the smart ring is tapped twice within a specified interval, the pointer control module opens the item selected on a screen of the computing device or pops up the menu including options on the selected item.
